(19) United States
(12) Patent Application Publication
(10) Pub. No.: US 2003/0201871 A1
(43) Pub. Date: Oct. 30, 2003

(54) Process for producing new metal strip resistors and their structure

(76) Inventors: Fuh-Chyang Chern, Shin-Juang City (TW); Yi-Min Lin, Shin-Juang City (TW)

Correspondence Address: BRUCE H. TROXELL, SUITE 1404, 5205 LEESBURG PIKE, FALLS CHURCH, VA, 22041, US

(21) Appl. No.: 10/134,367

(22) Filed: Apr. 30, 2002

(51) Int. Cl. H01C 1/012

(52) U.S. Cl. 338/309

(57) ABSTRACT

This invention is a process for producing metal strip resistors, i.e., forming the two electrodes at the two ends of an metal strip with thick electroplating and laying a layer of coating on the surface of the metal strip for heat radiation (a metal cooling plate may be pasted onto the coating when necessary). The producing procedures include rolling, punching, electroplating, cutting, grooving, coating, fixing the cooling plate, and drying. The finished product is the metal strip resistor described in this invention. The said electrode production method can maximize the contact surface between the electrodes and the base strip to pass more current and decrease the resistance valve (usually to 0.0001 ohm). The heat ventilating plate on the base strip can facilitate heat emission to stabilize the resistance valve and enhance its capacity.

### DOMAIN OF INVENTION

This invention provides a process for producing metal strip resistors, wherein, forming the two electrodes at the two ends of a metal strip with thick electroplating can provides a large contact surface than that formed in traditional producing processes, which can pass more current and minimize the resistance valve. In addition, the better heat emission capacity of this product can minimize the error of resistance.

### BACKGROUND OF INVENTION

Metal Strip Resistors (mainly SMD resistors on PC cards) are usually used in high current/power environments, and are referred as Current Sensing Resistors. Traditionally, the electrodes of a SMD resistor are formed on the two ends of a metal strip by welding, which is shown in the following Pictures.

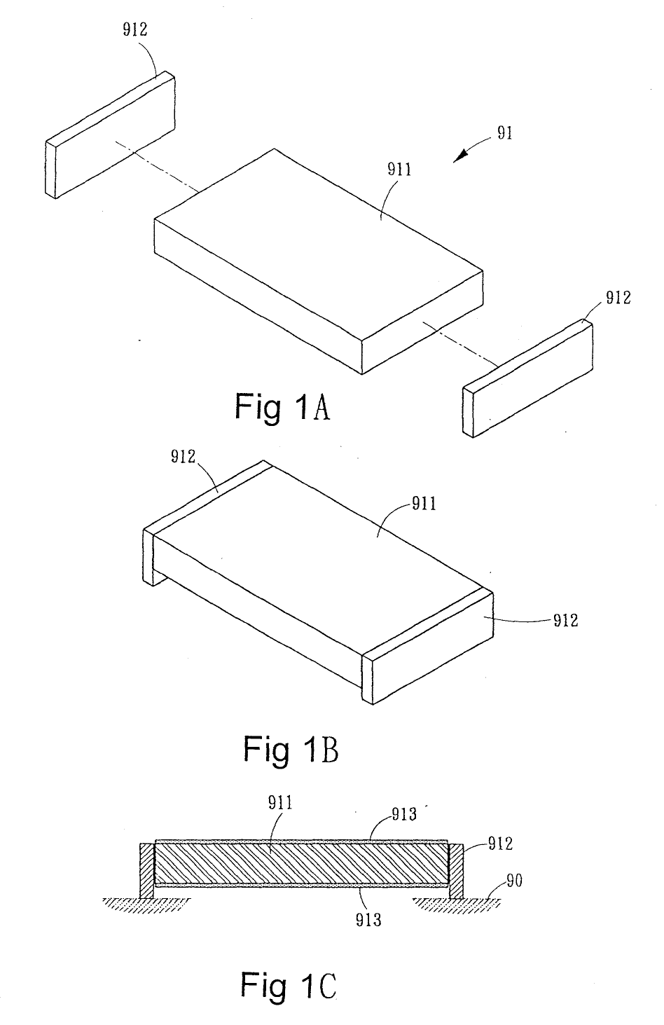

Please see FIG. 1A—a 3D exploded view of a traditional metal strip resistor. The resistor (91) comprises of a base strip (911) and two bar electrodes (912) formed with welding (usually at 2,000 or above) on the two ends of base strip 911. The assembly structure of it is shown in FIG. 11B. A coating is laid on the surface of base strip 911. However, the problem is that when resistor 91 is applied on a PC card, due to the small contact surface between bar electrodes (912) and the PC card (90), the current passing through the resistor is limited, and the fixing effectiveness is affected to some extend.

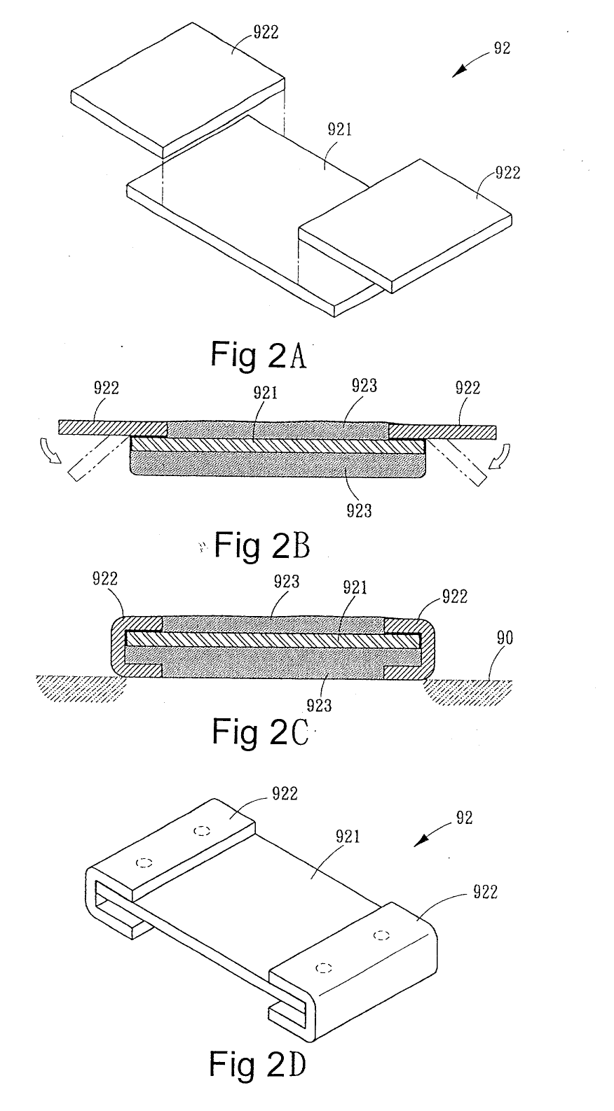

FIG. 2A is a 3D exploded view of another traditional metal strip resistor. From the picture we can see that the resistor (92) comprises of a base strip (921) and two electrodes (922) welded at the two ends, and a coating (923) is laid on base strip 921 (as shown in FIG. 2B). The thin steel plate electrodes (922) are bended to form a “C” pattern, as shown in FIG. 2C. In this way, when the resistor (92) is mounted on a PC card (90), there is a larger contact surface between them. However, the problem is that the sizes of electrodes 922 are relatively small, thus it is difficult to bend. Moreover, due to the edge of welding is not stable, the current passed and the resistance are stilled limited to some extend. Another producing process is shown in FIG. 2D, wherein the electrodes (922) are welded via a pointing welding process to fuse together with the base strip (921). However, the effective contact surface between the electrodes and the base strip is hard to estimate, and the variation of it during temperature alternation will affect the accuracy of the resistance value.

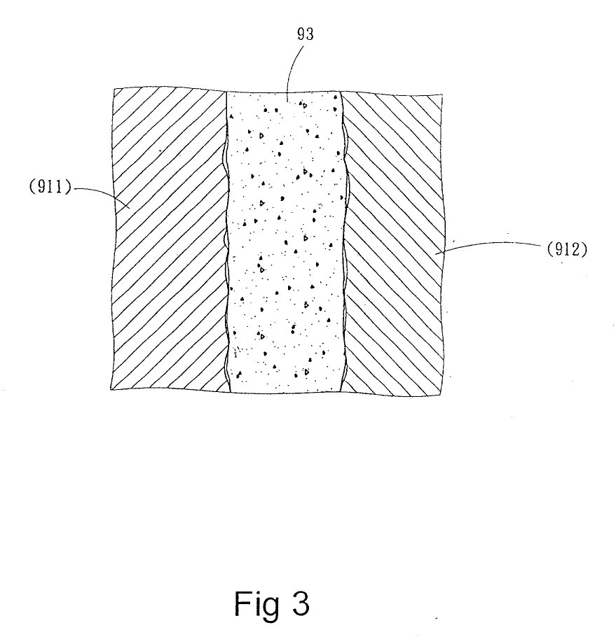

Please see FIG. 3—a zoomed illustration of the welded fixing between the base strip and the electrodes of traditional metal strip resistors. In the welding process, the tin paste (or silver paste) (93) is usually used as the welding media, which often contain gas bubbles. Under microscopes we can see that the contact between base strip 911 (or 921) and electrodes 912 (or 922) often contain small gas bubbles or gas cells, which can result in oxidization. In addition, due to the low fusing temperature and high resistance of tin paste 93 (or silver paste), the conductivity of the contact surface may be decreased. Due to the extreme high temperature of electro-welding, base strip 911 (or 921) or electrodes 912 (or 922) may deteriorate, especially in the area near the welding point, which will increase the error of resistance, which will decrease the accuracy of resistance.

In consideration of above situations, the main aim of this invention is to overcome the shortcomings of traditional metal strip resistors to meet the requirements for high current, low resistance, and high power.

### TECHNICAL APPROACH OF INVENTION

The main feature of this invention lies in: forming the two electrodes at the two ends of the base strip (alloy strip) by thick electroplating. The electrode covers not only the top and bottom faces of the end but also the two side faces, which will maximize the total contact surface. In addition, a coating is laid on the surface of the base strip, and even a heat ventilating metal plate can be fixed on the surface to facilitate the heat emission.

The producing process of the metal strip resistor described in this invention is as follows:

1. Rolling: roll the metal plate into a strip;

2. Punching: punch the base strip into a grid one with a mould, and produce a locating hole at the center of the strip;

3. Electroplating: galvanize the top and bottom faces and the two side faces of the base strip with low temperature thick electroplating to form the electrode;

4. Cutting: cut the galvanized base strip into bars;

5. Grooving: cut grooves on the bars to determine the resistance valve;

6. Coating: lay a coating on the surface of the bar but leave the two ends exposed to form the two electrodes. The coating material should be good in heat radiation, heat resistant, and UL-compliant.

7. Fixing the heat radiating plate: When the coating is half dry, stamp the heat radiating plate on the surface of the base strip. Wait till the coating dries and the heat radiating plate is fixed on the strip surface. Then the metal strip resistor is finished.

The finished product will be verified and shipped for industrial use.

### PURPOSE OF INVENTION

In this invention, because the electrodes are formed at the two ends of the base strip with low temperature thick electroplating, the base strip and the electrodes are not easy to deteriorate, and the contact surface is relative large. In addition, because that the electrode covers the entire end of the base strip, the total contact surface between the electrode and the base strip is 2˜4 times as that for traditional metal strip resistors (welded electrode). The electrode contacts seamlessly with the base strip, and there is no gas bubbles or gas cells in the coating layer. Thus, the strip resistor can tolerate higher current passing through, and the resistance value can be decrease to 0.0001 ohm.

The large contact surface also facilitates the heat radiation. Along with the heat radiating plate, the total heat radiating capacity of the resistor is higher, which decreases the working temperature and the error of resistance valve, as well as enhance the horsepower capacity of the resistor.

Embodiments

The embodiments are illustrated and described as follows:

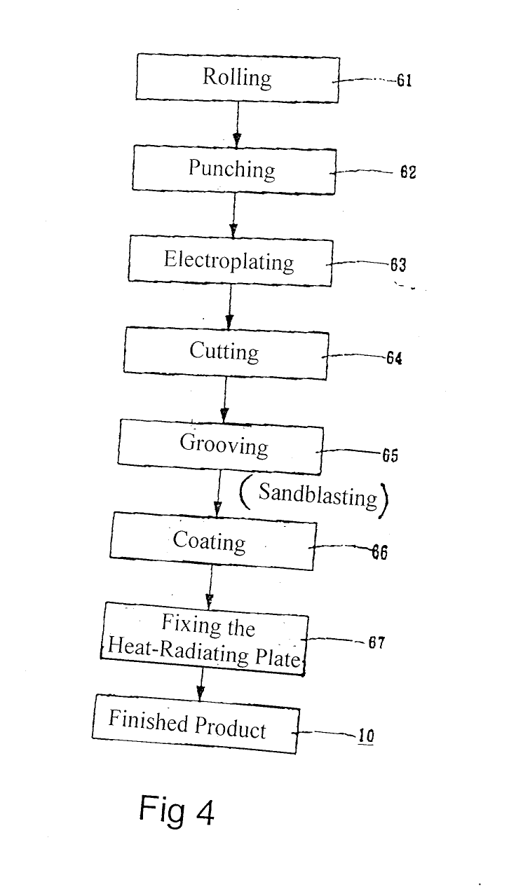

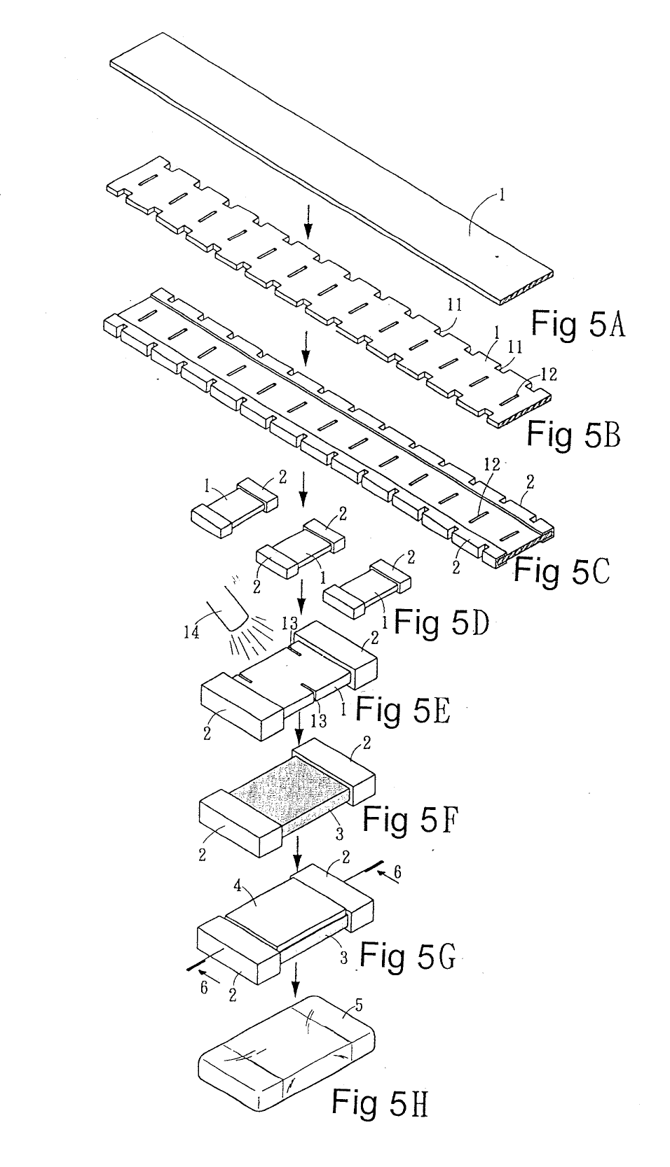

Please see FIG. 4 and FIG. 5A˜FIG. 5H, in which, FIG. 4 is the producing flow chart of the resistor described in this invention; FIG. 5A˜FIG. 5H are sketch maps of the producing procedures of the resistor. From the pictures we can see that the producing procedures of the resistor (10) include:

1. Rolling (61): roll the alloy plate into a strip (1) (as shown in FIG. 5A);

2. Punching (62): punch the base strip (1) into grids (11) at an even interval, and produce a positioning hole (12) at the center of strip 1 (as shown in FIG. 5B);

3. Electroplating (63): forming the two electrodes (2) at the two ends of base strip I with low temperature thick electroplating (as shown in FIG. 5C);

4. Cutting (64): cut the electroplated base strip 1 into bars along the grids (11) and the positioning hole 12 (as shown in FIG. 5D);

5. Grooving (65): cut out one or more grooves (13) on base strip 1 to determine its resistance value. And get rid of burrs with sandblasting (14) or other processes (as shown in FIG. 5E);

6. Coating (66): lay a layer of coating (3) on the surface of the base strip but keep the two ends (electrodes) exposed. Coating 3 is a kind of material excellent in heat radiation and heat endurance (as shown in FIG. 5F);

7. Fixing the heat radiating plate (67): lay the heat radiating plate (4) on coating 3 when coating 3 is half dry. When coating 3 completely dries, the heat radiating plate 4 will be fixed on the surface of base strip 1. Thus the metal strip resistor (10) is finished.

When above procedures are over, the finished product can be verified, encapsulated (5), and shipped (as shown in FIG. 5H) for industrial use.

The finished product 10 right is the prototype and embodiment of the metal strip resistor described in this invention. Therefore, any producing process or product structure implemented with forming electrodes (2) on the two ends of a base strip (1) with thick electroplating or forming electrodes (2) on the two ends of a metal strip (1) with thick electroplating and further cutting the metal strip 1 into bars should fall into the category of this invention.

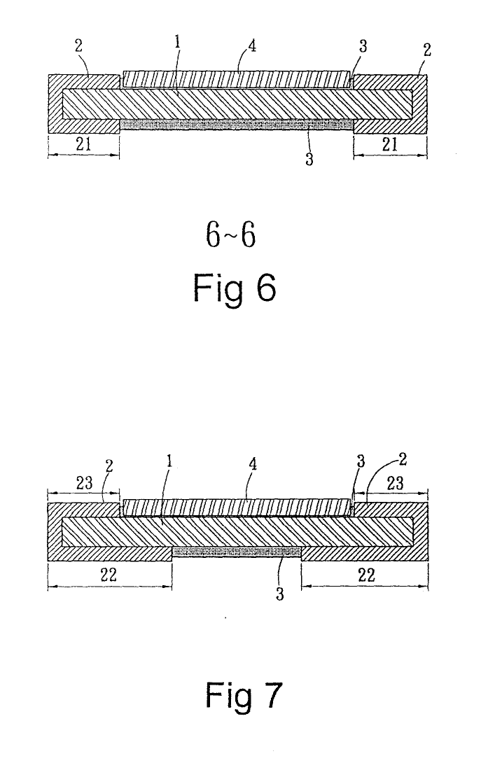

Please see FIG. 6, a sectional view of FIG. 5G cut along line 6-6, from which we can see that the resistor (10) comprises a base strip (1), the electrodes (2) at the two ends of base strip 1, a layer of coating (3) evenly distributed on the surface of base strip 1 (including top face, bottom face, and two side faces), and even a heat radiating plate (treated with a insulation process) fixed on coating 3, in which, the electrodes 2 are seamlessly attached on base strip 1, forming a bubble-free layer. From FIG. 5D we can see that electrodes 2 covers the entire ends (including the top face, bottom face, and two side faces) of the base strip 1. However, in traditional metal strip resistors, the electrodes only cover a top/bottom surface or a side face of the two ends. Thus the contact surface of this invention is 2˜4 times as that of traditional ones. The larger contact surface of this invention can decreases the resistance value to 0.0005˜0.5 ohm, compared to the value of 0.005˜0.5 ohm in traditional ones. The horsepower capacity of this invention is also improved. Furthermore, the coating 3 is a material excellent in heat emission, heat endurance, and UL-compliant. Therefore, the heat radiating capacity of resistor 10 is relatively good, and the error of resistance can be controlled under 0.1%. The bottom face of electrode 2 is a plain, which can contact well with the PC card (7) when it is fixed.

FIG. 7 demonstrates another embodiment of this invention. The difference between this figure and FIG. 6 lies in that the bottom face (22) of electrode 2 is relatively long and wide, and is longer than the top face (23). It provides a larger contact surface between the electrode 2 and the PC card 7.

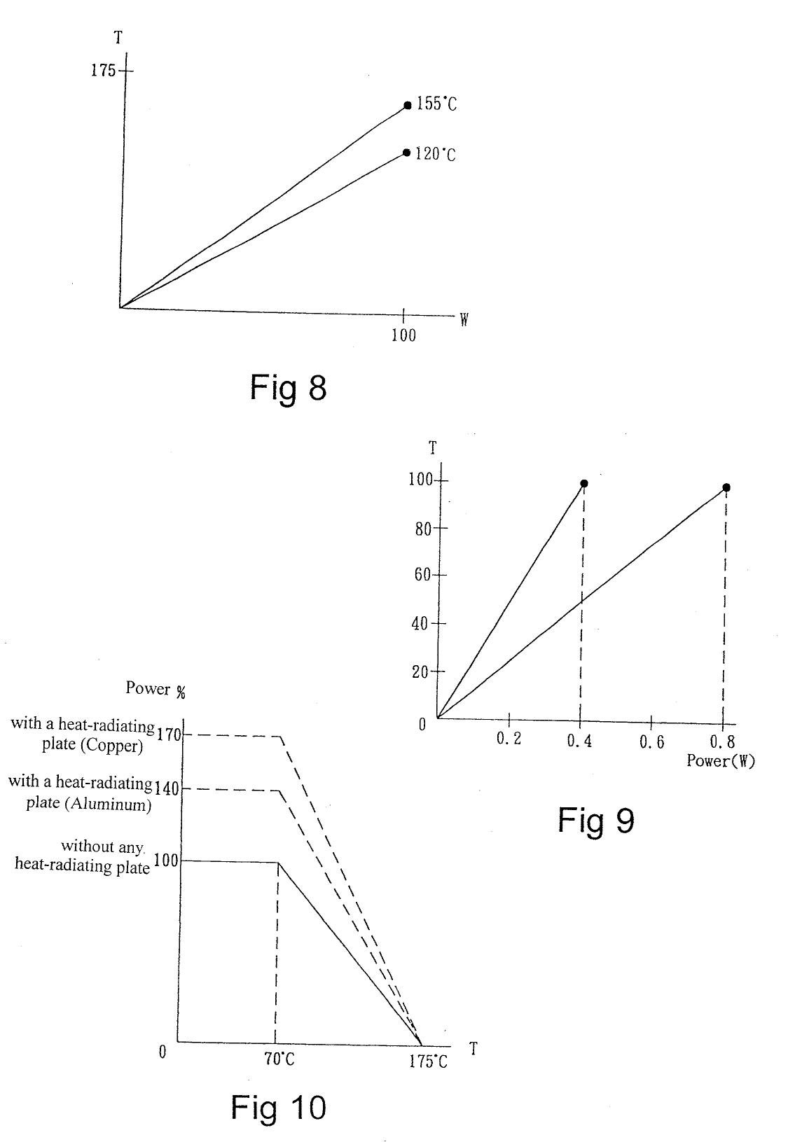

FIG. 8 is a temperature comparison chart between the resistor of this invention and traditional ones, in which, the slope line (R1) indicates that the temperature of a traditional resistor is 155 under 100W power, while the slope line (R2) indicates that the temperature of the resistor of this invention is only 120 under the same power. We can see that the latter is lower.

FIG. 9 is a horsepower comparison chart between the resistor of this invention and traditional ones, in which, the slope line (3) indicates that the power carried by a traditional resistor is about 0.4W when the temperature of resistor rises to 100 , while the slope line (4) indicates that the power carried by the resistor of this invention is about 0.8W at the same temperature. We can see that the horsepower capacity of the resistor of this invention is better.

From FIG. 8 and FIG. 9 we can conclude that the resistor of this invention is better than traditional ones both in heat radiation and horsepower.

FIG. 10 is a horsepower comparison chart between the resistor of this invention with a heat radiating plate and traditional ones without any heat radiating plate, in which, the curve (R5) indicates that the power carried by a traditional resistor is 100% at 70 and drops slowly along with the temperature increases after that point, while the curve (R6) indicates that the power carried by the resistor of this invention with a aluminum plate is 140% at 70 and drops slowly along with the temperature increases after that point, and when a copper plate is applied to the resistor of this invention, as shown in curve R7, the power is 170% at 70 and decrease slowly after that point. From above values we can see that when a heat radiating plate is applied to this resistor, the horsepower capacity of this resistor is much better than that of traditional ones, and copper plate is better than aluminum plate.

We can conclude from above analysis that this producing process can enlarge the contact surface between the electrode and the base strip, which in turn ensure higher current passing through and result in lower resistance valve. Adding a heat radiating plate on the surface of base strip can further improve the heat ventilating capacity, the accuracy of resistance, and the horsepower capacity in consideration of the practical industrial value of this producing process and the structure of this invention, I hereby apply for a new patent.

### INSTRUCTION OF DIAGRAMS

FIG. 1A is a 3D exploded view of a traditional resistor (1);

FIG. 1B is a combined diagram of a traditional resistor (1);

FIG. 1C is a sectional view of a traditional resistor (1);

FIG. 2A is a 3D exploded view of another traditional resistor (2);

FIG. 2B is a sketch map of the structure of the resistor in FIG. 2A;

FIG. 2C is a sketch map of the embodiment of the resistor in FIG. 2A;

FIG. 2D is a 3D sketch map of another traditional resistor (3);

FIG. 3 is a microscopic sketch map of the structure between the electrode and the base strip of a traditional resistor;

FIG. 4 is the producing flow chart of the resistor described in this invention;

FIG. 5A˜5H are sketch maps of producing procedures of the resistor described in this invention.

FIG. 6 is a sectional view of FIG. 5G along Line 6-6;

FIG. 7 is a sectional view of another embodiment of the resistor described in this invention;

FIG. 8 is a temperature comparison chart between the resistor in this invention and traditional ones.

FIG. 9 is a horsepower comparison chart between the resistor in this invention and traditional ones after the temperature rises up.

FIG. 10 is a horsepower comparison chart between the resistor in this invention with a heat radiating plate and traditional ones without any heat radiating plate.

### INSTRUCTION OF SYMBOLS

1. Traditional Resistor:

| | |
|---|---|
| 90 PC Card | 91 Resistor |
| 911 Base Strip | 912 Electrode |
| 92 Resistor | 921 Base Strip |
| 922 Electrode | 923 Surface |
| 93 Tin Plate | |

94. Resistor of This Invention:

| | |
|---|---|
| 10 Resistor | 1 Base Strip |
| 11 Grid | 12 Positioning Hole |
| 13 Groove | 14 Sandblasting |
| 2 Electrode | 21 Bottom Face |
| 22 Bottom Face | 23 Top Face |
| 3 Coating Layer | 4 Heat Radiating Plate |
| 5 Encapsulation | 61 Rolling |
| 62 Punching | 63 Electroplating |
| 64 Cutting | 65 Grooving |
| 66 Coating | 7 PC Card |

What I claimed here is:

1. A process for producing new metal strip resistors, i.e., forming the electrodes at the two ends of a metal strip (base strip) with thick coating to make the electrodes contact seamlessly with the base strip, which ensures higher electric current passing through and decreases the resistance value.

2. The producing process as in claim 1, wherein the producing procedures include:
Rolling: roll the alloy plate into a strip;
Electroplating: forming the two electrodes at the two ends of base strip with low temperature thick electroplating;
Cutting: cut the electroplated base strip into bars along the grids and the positioning hole.

3. The producing process as in claim 2, wherein the said base strip can be punched into grids at an even interval and a positioning hole at the center.

4. The producing process as in claim 2 or 3, wherein one or multiple groove can be cut out on the said base strip after electroplating.

5. The producing process as in claim 4, wherein the surface of the base strip can be treated with sandblasting or grinding after cutting;

6. The producing process as in claim 5, wherein a coating is laid on the surface of the base strip.

7. The producing process as in claim 6, wherein a heat-radiating metal plate can be fixed on the coating.

8. The producing process as in claim 2 or 3, wherein a coating can be applied on the surface of the base strip for heat radiation.

9. The producing process as in claim 8, wherein a heat-radiating metal plate can be fixed on the heat-radiating coating.

10. The producing process as in claim 2 or 3, wherein a coating can be laid on the surface of the base strip and a heat-radiating plate can be fixed on the coating.

11. A metal strip resistor structure comprising of a base strip (alloy plate), two electrodes fixed on the two ends of the base strip, and a heat-radiating plate fixed on the base strip, to implement better heat-radiating capacity, less distortion of resistance value, and high horsepower carried.

12. The electric resistor structure as in claim 11, wherein the electrode covers the entire surface (including the top face, the bottom face, and the two side faces) of the end of base strip.

13. The electric resistor structure as in claim 11 or 12, wherein the bottom face of the electrode is longer that the top face of it.

14. The electric resistor structure as in claim 11, wherein the heat-radiating plate is a copper plate treated with an insulation process.

15. The electric resistor structure as in claim 11, wherein the heat-radiating plate is an aluminum plate treated with an insulation process.

16. The electric resistor structure as in claim 11, wherein the heat-radiating plate is fixed onto the base strip via the coating layer.
